(19) United States
(12) Patent Application Publication
(10) Pub. No.: US 2017/0083980 A1
(43) Pub. Date: Mar. 23, 2017

(54) SYSTEM AND METHOD FOR MORTGAGE INSURANCE CLAIMS COST REDUCTION

(71) Applicant: HVG, Inc., Brockton, MA (US)

(72) Inventors: James M. Connolly, Dover, MA (US); John E. Marthinsen, Sherborn, MA (US)

(21) Appl. No.: 14/862,806

(22) Filed: Sep. 23, 2015

(51) Int. Cl. G06Q 40/08; G06Q 40/02

(52) U.S. Cl. CPC G06Q 40/08; G06Q 40/025

(57) ABSTRACT

A Subject MI policy is enhanced by two new features that decrease the frequency of foreclosures and lower the total cost of claims such that the provider becomes the low cost producer. These features comprise advances of up to 6 months of mortgage payments to the lender on behalf of the homeowner following verifiable involuntary job loss, and payments for underwater insurance claims to the lender on behalf of the homeowner equal to the difference between the mortgage balance and the higher of the resale price or index value of the home when sold. The information technology (IT) platform enables seamless integration of the new features with lender and servicer systems. The counterintuitive cost advantage of such enhanced policies is revealed by a comprehensive financial analysis of conservative assumptions.

### INCORPORATION-BY-REFERENCE OF MATERIAL SUBMITTED ON COMPACT DISC

Materials (e.g., tables) are submitted on one compact disc (Copy 1), together with a duplicate thereof (Copy 2), each created on Jun. 19, 2015, and each containing one 12.2 MB file entitled HVG Financial Model-03 19 2015.xml and one 1.62 MB file entitled HVG Financial Model-03 19 2015.xlsm. The materials contained on the compact disc are specifically incorporated herein by reference.

### BACKGROUND

Technical Field

The present invention generally relates to systems and methods for mortgage insurance (MI) cost reduction.

Description of Related Art

Conventional/traditional MI provides credit risk protection to lenders with policies whose premiums are paid by borrowers. MI is defined by the National Association of Insurance Commissioners (NAIC). MI providers are monoline, meaning that, pursuant to the NAIC Mortgage Insurance Model Act, such providers can sell only MI.

MI is required by two Government Sponsored Enterprises (GSEs), Fannie Mae and Freddie Mac, when the loan-to-value (LTV) percentage exceeds 80%. The GSEs purchase mortgage loans from lenders and securitize them, usually in the form of bonds sold to investors. The bonds entitle investors to share in the principal and interest payments made by borrowers. The value of this payment stream has been priced by a complex algorithm, which calculates relevant factors, such as attrition, established by the Public Services Association Standard Prepayment Model (PSA), and estimated changes in factors such as interest rates, foreclosures, housing prices, and other factors affecting the longevity of the underlying loans that remain the property of the GSEs. Secondary markets in mortgage loans provide liquidity to the housing market.

While conceptually competitive, the market for MI comprises lenders whose primary focus is on distributing risk and avoiding overexposure to an insufficient number of MI providers. Borrowers do not choose their MI provider. Such decisions are made by lenders, with a mouse click that directs borrowers to a particular MI provider. MI rate cards among the various MI providers are virtually identical, which enables lenders to toggle between providers without affecting MI pricing.

Conventional MI failed dramatically during the housing market collapse experienced in the 2007-2010 period, called the Great Recession. There were well-documented abuses that contributed to this collapse of the housing market, including ill-conceived mortgage products, predatory lending, consumer fraud, faulty regulatory practices, and irresponsible risk transfers.

There were no effective buffers against a systemic downward spiral in housing prices, which averaged 33% nationally. There was no effective mechanism in place to reduce foreclosure rates that reached historical highs, sending the housing price spiral far below a rational correction point. While no single product would have overcome the mortgage industry's abuses that led to the Great Recession, the depth of the drop could have been reduced if a mechanism had been in place to keep homeowners from defaulting.

A new phenomenon occurred during the Great Recession, called strategic defaults i.e. buyers with the means to pay their debts, instead walked away from their houses and mortgage obligations. The principal causes were substantial negative equity and a belief that the housing market would not recover for a long time.

Millions of homeowners strategically defaulted, preferring to incur credit impairment and other negative externalities, rather than pay down mortgage balances above market values (negative equity). The foreclosure rate, which historically had been approximately 3%, more than doubled.

Conventional MI providers have encountered long implementation delays because they built proprietary data portals to their individual customers, resulting in long system queues.

### BRIEF SUMMARY

Methods, systems, and apparatuses, herein described show how a novel MI policy can be offered at the same price as traditional MI, despite extending more benefits, and also substantially reduce MI costs. A computer model is also included to demonstrate the savings that come from keeping families in their homes, rather than engaging in strategic defaults.

### BRIEF DESCRIPTION OF THE DRAWINGS/FIGURES

The accompanying drawing, which is incorporated herein, and forms part of the specification, illustrates and describes embodiments that will be helpful to a skilled person considering uses of this patent.

FIG. 1 is a block diagram showing a computer that may be configured to perform techniques disclosed, herein.

The features and advantages of the MI embodiments described herein, will become more apparent from the detailed description set forth below—especially when read in conjunction with the incorporated drawing and computer model. In the drawing, reference numbers are used to identify identical, functionally similar, and/or structurally similar elements.

### DETAILED DESCRIPTION

### I. Introduction

The present specification discloses numerous nonexclusive embodiments. Therefore, the scope of the present patent application is not limited to the disclosed embodiments but rather also encompasses combinations and modifications of them.

References in the specification to “one embodiment,” “an embodiment,” “an example embodiment,” etc. indicate that the embodiment described may include a particular feature, structure, or characteristic but every embodiment may not necessarily include the particular feature, structure or characteristic. Moreover, such phrases are not necessarily referring to the same embodiment. Further when a particular feature, structure, or characteristic is described, it is submitted that it is within the knowledge of one skilled in the art to affect such feature, structure, or characteristic in connection with other embodiments whether or not explicitly described, herein.

Descriptive terms used, herein, such as “about,” “approximately,” and “substantially” have equivalent meanings and may be used interchangeably.

The terms “coupled” and “connected” may be used synonymously herein, and may refer to physical, operative, electrical, communicative, and/or other connections between components described herein, as would be understood by a skilled person in the relevant art(s) having the benefit of this disclosure.

Numerous embodiments are described, herein. Any section/subsection headings provided herein are not intended to be limiting. Embodiments are described throughout this document, and any type of embodiment may be included under any section/subsection. Furthermore, it is contemplated that the disclosed embodiments may be combined with each other in any manner.

### II. Example Embodiments

A system and method are described herein, for reducing the cost of MI by the introduction of new benefits for lenders, borrowers, investors, and other stakeholders. Part of this innovation is the requirement that these benefits be inseparable. For the same price as traditional MI, this product provides traditional compensation to lenders in cases of default, relief for borrowers during periods of involuntary unemployment and also compensates policyholders for the loss of home equity upon sale. These features reduce defaults and foreclosures and hinder systemic declines in real estate prices by reducing strategic defaults.

A reduction in foreclosure claims provides MI companies that issue these novel MI policies with net cost advantages over competitors. Over time, competitive pressures will induce across-the-board adoption of these new features, leading to greater stability in housing prices during economic downturns.

The new policy features can be seamlessly connected to existing lender and servicer systems by means of exchange, loan origination system (LOS), and servicing software. The counterintuitive cost advantage of the proposed MI policy is explained by a comprehensive, interactive financial model, which permits users to enter more than 100 assumptions on housing, economic, and financial conditions, such as inflation, frequency, severity, and foreclosure rates.

The two MI policy features that will redefine this insurance sector are: (1) advances for a maximum of six monthly mortgage payments, where such payments are made: directly to lenders on behalf of borrowers, and only if there is verifiable evidence of involuntary job loss; and (2) payments for underwater insurance claims, where such payments are made: directly to the lender on behalf of the borrower, and equal to the difference between the mortgage balance and the higher of the property's resale price or the housing index value of the home when sold. These inseparable policy benefits are in addition to conventional MI coverage, which pays lenders a capped amount equal to 30% of the sum of the mortgage balance plus loan recovery expenses. Several reliable home price index systems include S&P/Case Shiller Index, FHFA Housing Price Index, and Core Logic Housing Price Index.

A. Unemployment Protection

The embodiments described herein provide lenders, servicers, and homeowners with protection when the borrower experiences involuntary job losses. More specifically, up to six monthly mortgage payments are advanced to the lender/servicer under the following conditions:
1. The borrower provides evidence of involuntary job loss and is current on “monthly mortgage payments” prior to unemployment, where “monthly mortgage payments” include principal, interest, taxes, and homeowner insurance (PITT).
2. Advances are made to the lender in order to comply with the monoline requirements of the NAIC's Model Act. If the advances were made to borrowers, such transactions might be construed by state regulators to be surety insurance.
3. To comply with the NAIC's monoline rules, advances must be repaid by the borrower. Otherwise, insurance payments to lenders would benefit borrowers (not lenders), causing a monoline violation.
4. Upon default, insurance claims filed by lenders will be offset by any unemployment advances.
5. If no insurance claim is filed and the mortgage is satisfied, the advances, which were documented with a note payable, must be repaid upon the home's sale, refinancing, or upon loan maturity.
6. When an advance is made, a lien is attached to the property, thereby virtually assuring that the property will not be sold without extinguishing this claim. The new purchaser of the property is responsible for payment of the lien, which is superior to the new mortgage because it is first-in-time. Neither the new purchaser nor the new lender should accept such a lien.

The median duration of unemployment during the Great Recession period of 2007-2010 was slightly under six months, according to the data provided by the US Department of Labor, Bureau of Labor Statistics (see e.g., http://research.stlouisfed/fred2/series/UEMPMED/dowmloaddata?cid=12).

Unemployment advances, as provided herein, are consistent with the Consumer Financial Protection Board's “National Servicing Standards” and “Qualified Mortgage” rules.

B. Underwater Protection

Embodiments described herein, provide lender and homeowner protection against underwater mortgages, which are properties whose market values are less than their mortgage balances. With respect to such underwater mortgage claims, payment is limited to 25% of the outstanding mortgage balance, is paid only upon sale of the property, and made directly to the lender/servicer, based on the greater of the sale price or index value of the property. Payment is also subject to a progressive vesting schedule, with outlays equal to 0% of the mortgage balance in Policy Year 1, 6.25% in Policy Year 2, 12.5% in Policy Year 3, and 25% in Policy Year 4 and thereafter. Finally, payment is contingent upon the homeowner being current on PITI payments.

Deeply underwater borrowers have an incentive to walk away from their mortgages. When they do, their homes often fall into disrepair, and the assets lose significant value, with mortgage insurers bearing much of the burden of these losses.

By covering the first 25% of negative equity, the Subject MI provides an incentive for borrowers not to strategically default, thereby reducing the likelihood of foreclosures. The Subject MI's payment in such a scenario is significantly lower than the avoided potential losses through foreclosure.

The Subject MI's underwater insurance does not incentivize homeowners to file claims as soon as they are underwater. There is an inherent “deductible” that guards against this in the form of transaction costs associated with selling a home and buying another. Such transaction costs mitigate the number of claims from homeowners who are marginally or moderately underwater.

To file an underwater claim, the borrower must first sell the home. Selling a property and moving involves significant transaction costs, such as realtor fees, moving expenses, closing costs, and down payment for the new property. Given that the property is underwater, the seller also loses the down payment on the underwater home.

The following is an example of Traditional MI versus the Subject MI, assuming a $360,000 purchase price with a mortgage balance in Year 4 of the loan equal to $319,770. Calculations are shown in Table 1 below.

In this example, a 5% down payment is assumed, yielding an initial loan to value ratio LTV) of 95% on a 30-year, fixed rate loan. Finally, loan recovery costs are assumed to be $8,000, which is a conservative estimate that includes expenses, such as homeowners insurance, property taxes, interest, maintenance and upkeep, as well as legal cost that is capped at 3% of the mortgage balance.)

Continuing with the example, the Traditional MI claim amount is $98,331, regardless of the percent by which a home is under water. This FIGURE is determined by multiplying 30% (i.e., the assumed Traditional MI coverage) times the sum of the outstanding mortgage plus loan recovery expenses.

Unlike Traditional MI, Subject MI claims vary with the percent by which a home is under water. In Table 1, these amounts vary from a low of $31,977, when a home is 10% under water, to a high of $79,943, when a home is 30% underwater—which is still lower than the Traditional MI claim. Subject MI claims are calculated as the difference between the outstanding mortgage balance in Year 4 and the current value of a home (i.e., its re-sale price), with a maximum claim payment equal to 25% of the outstanding mortgage balance. Because homeowners do not default prior to the sale of their house, there is no need to pay loan recovery expenses. Therefore, if a home were 15% underwater, the Subject MI claim would equal $47,965 (i.e., which is $319,770−$271,805). The Subject MI payment satisfies the mortgage balance and, at the same time, enables the borrower to avoid foreclosure.

In this example, Subject MI's claim expenses are $50,366 less than Traditional MI, which is part (but not all) of the reason Subject MI can offer its consumers more benefits than Traditional MI but at the same premium cost.

Thus, Subject MI insurance provides borrowers with a better option because their credit ratings remain at previous levels and the reason to strategically default (i.e., negative equity) is eliminated.

In the last two columns of Table 1 the Subject MI claim payments are essentially the same (i.e., $79,943) when a home is 25% and 30% under water. This is because the maximum Subject MI payout is 25% of the outstanding mortgage.

TABLE 1
Comparison of Traditional & Subject MI Using Different Under Water Percentages

| | | Underwater Percentage | | | | |
|---|---|---|---|---|---|---|
| 1 | | 10% | 15% | 20% | 25% | 30% |
| 2 | Home Purchase Price | $360,000 | $360,000 | $360,000 | $360,000 | $360,000 |
| 3 | 5% Down Payment | $18,000 | $18,000 | $18,000 | $18,000 | $18,000 |
| 4 | Mortgage Amount | $342,000 | $342,000 | $342,000 | $342,000 | $342,000 |
| | (Row 2 − Row 3) | | | | | |
| 5 | Mortgage Balance Year 4 | $319,770 | $319,770 | $319,770 | $319,770 | $319,770 |
| 6 | Current Home Value | $287,793 | $271,805 | $255,816 | $239,828 | $223,839 |
| | [Row 4 − (Row 1 × Row 4)] | | | | | |
| 7 | Underwater Amount | $31,977 | $47,965 | $63,954 | $79,942 | $95,931 |
| | Row 5 − Row 6 | | | | | |
| 8 | Market Loss | $72,207 | $88,195 | $104,184 | $120,173 | $136,161 |
| | (Row 2 − Row 6) | | | | | |
| 9 | % Home Value Loss | 20.1% | 24.5% | 28.9% | 33.4% | 37.8% |
| | Row 8/Row 2 | | | | | |
| 10 | Loan Recovery Expenses | $8,000 | $8,000 | $8,000 | $8,000 | $8,000 |
| 11 | Traditional MI Payment | $98,331 | $98,331 | $98,331 | $98,331 | $98,331 |
| | 30% × (Row 5 + Row 10) | | | | | |
| 12 | Subject MI Payment | $31,977¹ | $47,965¹ | $63,954¹ | $79,942¹ | $79,943² |
| | The lesser of Underwater | | | | | |
| | amount (Row 7) or 25% | | | | | |
| | times the mortgage | | | | | |
| | balance (Row 5) | | | | | |
| 13 | Difference | $66,354 | $50,366 | $34,377 | $18,389 | $18,388 |

¹Satisfies mortgage balance
²Payment capped at 25% of mortgage balance

Subject MI policies' underwater benefits discourage prospective strategic defaulters and also prospective non-strategic defaulters. One reason is that many US families are dual income earners, which enables them to qualify for mortgage loans on the homes they purchase. When one of the wage earners loses his/her job, savings can be depleted during the unemployment period. Eventually the home becomes unaffordable on a single income. If the home mortgage is underwater, economic pressure to default would build in the absence of the Subject MI policy, which would cover the amount of negative equity and facilitate a move into a home that is affordable at the lower income level.

To the extent that Subject MI reduces defaults and foreclosures, there is also a macroeconomic advantage from redefining Traditional MI. By stemming defaults and reducing below market foreclosure sales, systemic reductions in real estate prices can be avoided, which promotes financial health for our thinly capitalized lenders. Keeping borrowers in their homes aligns the interests of a broad cross-section of our economy.

A societal value results from sustaining homeownership by providing relief in times of economic stress. The Subject MI allows homeowners to make prudent decisions about personal investments that, for many, are the largest assets in their portfolios—ones that can directly affect their credit ratings.

The embodiments described herein provide benefits for lenders, borrowers, servicers, GSEs, and issuers of mortgage backed securities (MBS), as described below:
1. Lender benefits—provides a valuable product attribute to their customers; enhances image and helps solidify customer trust; strengthens market presence through marketing and advertising; stabilizes cash flows over the business cycle; lowers claim costs; results in greater loan originations.
2. Borrower benefits—provides peace of mind and inspires consumer confidence; assists in times of distress; protects credit ratings; reduces family disruptions; provides financial safety net; promotes sound decision making.
3. Servicer benefits—manages and minimizes the frequency of delinquencies, defaults, and foreclosures; reduces costs by decreasing non-performing loans.
4. GSE benefits—aligns with their mission to keep borrowers in their homes; reduces the need to adjust the collateral that backs mortgage security pools by removing non-performing loans.
5. MBS investor benefits—inspires greater confidence that loans will perform; provides greater certainty of pool duration; enhances returns on investment.

Aligning the interests of all mortgage stakeholders will result in greater market penetration and enhanced Subject MI profitability.

C. Calculation of the Counterintuitive Subject MI Cost Advantage

A CD with 30⁺, interactive, EXCEL-based spreadsheets has been filed herewith (see: HVG Financial Model-03 19 2015.xml) to prove the counter-intuitive conclusions that adding more benefits to a Traditional MI policy can: (1) reduce claim payments and (2) strengthen our financial system by reducing strategic defaults and the threat of systemic reductions in real estate prices. It provides comprehensive, 10-year projections for important financial statements and ratios, such as income statements, balance sheets, and cash flows under both generally accepted accounting practices (GAAP) and Statutory Accounting Practices (SAP). Flexibility in performing scenario analyses is supported by more than 100 assumptions, which can be changed by any user. Among these assumptions are yearly inputs regarding depreciation rates, interest rates, claims calculations, exposure and reinsurance costs, SG&A details, ultimate loss ratios, attrition, outstanding mortgage balance schedule, and loan repayment schedule. To ensure the GAAP and SAP financial statements are aligned, a comparison spreadsheet has also been included.

A summary worksheet provides an overview of: New Insurance Written, Insurance in Force, Risk in Force, Risk in Force to Surplus Ratio, Loss Ratio, Expense Ratio, Combined Ratio, Reinsurance, Reinsurance Cost/Year, Cash and Marketable Securities, Contingency Reserves, and Statutory Deposits.

The Summary Profit & Loss (P&L) spreadsheets calculate 10-year projections for: Premium revenue, SG&A expenses, Claim expenses, including foreclosure claims, Unemployment protection claims, Underwater protection claims, Foreclosure claims reduction due to unemployment advances, Foreclosure claims reduction due to the underwater benefit, Foreclosure claims reduction due to reinsurance, other expenses (excluding state premium taxes), Reinsurance expenses, State premium tax, Loss adjustment expenses, Federal taxes, State taxes, Net profit after taxes (NPAT), Sensitivity analysis for profits after taxes (PAT).

An Interactive Foreclosure Net Benefit Worksheet calculates a) the net cost benefit that results from subtracting the cost of underwater claims from the savings that results from related foreclosure avoidance, and b) the net cost benefit that results from subtracting unemployment advance claims net of repayments from the savings that results from related foreclosure avoidance.

The key variables include frequency and severity percentage assumptions for each of four housing price ranges; percentage foreclosure reduction assumptions for assumed Relative Price Indices; and percentage housing price changes. The Relative Price Index is the local housing price index at time of sale divided by the housing price index at time of purchase.

a. Underwater Claims Calculations

The description below relates to one particular cell in the spreadsheet (HVG Financial Model-03 19 2015.xml, filed herewith on the accompanying CD), specifically cell D158 in Worksheet IPG1.

Below is a description of the formulas that revealed a counterintuitive Reduction in Total Claims Cost. Conventional belief is that offering added insurance benefits increases the cost of claims.

Underwater claims formulas determine the first of two values that quantify the Subject MI cost advantage. The cost of Underwater Claims is subtracted from a concomitant reduction in the cost of foreclosure claims that results from the Underwater Claims benefit provided by the Subject MI policy.

b. Underwater Claims Formula Construction

Embodiments described herein instantly determine the value of underwater claims under a very large number of housing price assumptions because of the construction of the underwater claims formulas. What follows is a brief explanation of how the claims formulas are constructed, the four price ranges that are used, and the definition of key factors that are used in the formulas. Then, the basic Underwater Claims formula is detailed in full.

### 1. GENERAL EXPLANATION AND KEY DEFINITIONS

The claims formulas in the accompanying financial model are interactive, meaning that the reader can change any of the claims assumptions to produce different results.

Each claims formula consists of a series of IF/THEN statements that are related to a “Relative Price Index”. The relative price index is the relationship between the current value of a property and its value when purchased. The relative price index is a percentage that can be above or below or exactly at 100% (i.e. no price change). The formula and assumptions used to calculate a claim amount are determined by the range into which the relative price index falls: 1.) rising or unchanged average housing prices, 2.) fallen average housing prices that are still above the mortgage balance. 3.) fallen average housing prices below the mortgage balance but above the maximum payout level, 4.) fallen average housing prices at or below the maximum payout level.

Factors involved in calculating the claims amount include:
1. The value of mortgages insured in the year the policies were written net of cumulative attrition
2. Adjusted PSA—The percentage of policies redeemed or cancelled in each policy year
3. The percentage of houses sold at a price below the mortgage balance in a given year
4. The average claims payout expressed as a percentage of the mortgage balance

In the spreadsheet (HVG Financial Model-03 19 2015.xml, filed herewith on the accompanying CD), an underwater claims formula is presented and is explained below.

Housing Prices—Underwater Claims calculations are based on assumptions, including assumptions about changes in future housing prices. In the detailed formula description that follows, there are 25 assumptions in a single Underwater Claims formula.

Model Navigation—The tabs in the spreadsheet are abbreviations. “A” stands for Assumptions. A! means that the formula in a current cell in one worksheet (e.g. IPG1) of the spreadsheet is referencing a cell in another worksheet i.e. a cell in the Assumptions worksheet page.

The tab IPG1 means the “Insurance Company P&L in GAAP”. All Financial statements are calculated both under GAAP (Generally Accepted Accounting Principles) as well as under Statutory Accounting Principles (SAP). State Regulators look at SAP financial statements. Investors look at GAAP statements which are quite different —principally because contingency reserves (50%×Earned Premiums) are not recognized as expenses under GAAP but are expensed under SAP which produces much different profits. The SAP tab (worksheet) corresponding to IPG1 is IPS1.

Assumptions in any model—Although sometimes unrealized by readers, nearly every cell in every financial model is based on two critical assumptions: market growth rate and share of market. These two assumptions appear in the accompanying model (i.e., in the spreadsheet). In every predictive model the variable cost of goods depends upon top line (volume) assumptions which entail growth rate and share assumptions. Some fixed costs are not affected by volume but even they are assumptions. Cost of Goods is obviously predicated on projected raw material costs etc. Fundamental top line and cost assumptions are unavoidable in every financial model.

Accompanying Model Assumptions—The accompanying model makes the universal volume assumptions (market growth and market share). In addition to these universal assumptions there are particular assumptions related to Underwater Claims. Chief among these are housing price change assumptions, frequency, severity, and foreclosure offset assumptions. Nearly every term in the accompanying file's formulas refers to a cell on the assumptions page. Further, even those cells that don't refer directly to the Assumptions worksheet, rely on underlying assumptions. For example, Cell IPG1,C50 refers to the value of mortgages written in the “origination year” [2016]—the year in which the relevant policies were purchased. Cell C50 relies on cell C32 which in turn refers to 5 separate cells in the Assumptions worksheet. Bottom line: nearly every cell in the accompanying model unavoidably relies directly or indirectly on an assumption and in most cases on multiple assumptions.

Housing Price Assumptions—In both of the Underwater Claims formulas shown in the accompanying spreadsheet there are multiple references to line 169 in the Assumptions worksheet e.g. A!D$169/A!$C$169. Line 169 in the Assumptions Worksheet records the housing price index in the year for which the claims cost is being calculated [2017] divided by the housing price index for the year when the policies referred to in that claims cell were written [2016]. The result establishes whether housing prices rose [i.e. First condition: IF(A!D$169/A!$C$169>=1] from purchase year to sale year or fell and if so by what percentage. When housing prices have fallen between the year of purchase and the year of sale the percentage decline enables categorization of the decline into price ranges. One price range defines when prices have fallen but remain above the mortgage balance [i.e. Second condition: (IF(A!D$169/A!$C$169>=(1−A!$C$11)*OMB!B$43, where A!$C$11 is the Down Payment percentage and OMB!B$43 is the percentage remaining of the mortgage loan]. The second condition assumes that the first condition [i.e. prices rose] has not been met. If the second condition is met, housing prices fell but remain above the mortgage balance.

Refer to line 168 in the Assumptions tab in the attached model. Line 168 contains interactive assumptions of the amount by which housing prices will change from each year to the next. If, for example, a reader thinks that housing prices will decline in 2018 by 5%, −0.05 would be entered in cell A!E168. This would change the total cost of underwater claims, referred to in cell B147 of the HVG Overview Worksheet, from $11,238,089 to $17,855,070 and the cost benefit that is enjoyed over traditional MI providers will decrease to $14,090,771 from $17,482,539 as recorded in the Foreclosure Net Benefit cell E6. This is due in part to an increase in HVG Foreclosure Avoidance from $28,720,628 to $31,945,841.

A series of housing price percentage changes in line A! 168 may be experimented with in the spreadsheet, including changing every cell. The effect of these housing price percentage changes on the Cost Advantage appears in Foreclosure Net Benefit tab cell E6. The claims cost advantage of the Subject MI policies is maintained in all but the most draconian housing price reduction assumptions.

Frequency—In the accompany financial model/spreadsheet, frequency is defined as the percentage of houses sold in a given year that are below the mortgage balance. Frequency is one of two key variables used to calculate the cost of underwater claims, once the relevant price range has been established. Frequency is expressed as a percentage i.e. the percentage frequency of policies redeemed this year represents the percentage of these houses sold below the mortgage balance. The projected percentage frequency varies with the housing price range into which the Relative Price Index falls e.g. a Relative Price Index of 99% would fit in the housing price range that is below the purchase price but above the mortgage balance.

This model projects that 1.4% of houses sold in a risen housing price market will be sold at a price that is below the mortgage balance. The classic example is a house that was purchased for $100,000. In a market where housing prices have risen at a rate of 1% per year the index value of that house would be $102,010 at the end of two years. Assuming the mortgage value declines by approximately 1½% per year and the down payment is 7%, the mortgage balance would be (100,000×(1-7%)×97%)=$90,210 at the end of 2 years.

Therefore, the model projects that 1.4% of houses bought for $100,000 will be sold below $90,117 in Year 2 of a market where the average price of those homes has risen to $102,010. The reason is that housing markets are granular and some markets will experience declines while the national average is rising. A 10% housing price decline in two years is quite steep by historical standards, so it is estimated that only a small percentage of insured houses would be sold at a loss greater than 10% (round numbers). The formula is: $C$50*OMB!B$43*A!D$162*A!$B$90. A!$B$90 is a frequency assumption of 1.4%. IPG1,C50 is the Value of mortgages insured in the Origination Year net of attrition. OMB!B$43 is the unpaid mortgage balance percentage. A!D$162 is the percentage of policies originated in 2016 that are redeemed or foreclosed in 2017.

Frequency assumptions (Refer to Assumptions Tab line 90): RPI>1 means that housing prices have risen between the purchase of the house and the current year; ((1−% DP)×% Mortgage Bal.)≦RPI<1 means that the sale price is below the purchase price but above the mortgage balance. The frequency assumptions for RPI>1 and ((1−% DP)×% Mortgage Bal.)≦RPI<1 are shown below in Table 2.

TABLE 2

| | ((1 − % DP) × % Mortgage |
|---|---|
| | Bal) ≦ RPI < |
| RPI > 1 frequency % | 1 frequency % |
| 1.4% | 2.5% |

The frequency assumptions above are static. It would be beneficial to have dynamic assumptions. Specifically, the percentage frequency should be correlated with the mortgage balance. As the mortgage balance declines the percentage of houses sold below the mortgage balance should also decline. The correlation this model assumes is that for every 1½% reduction in the mortgage balance there is a concomitant 6.75% reduction in the frequency percentage i.e. the percentage reduction in frequency is 4.5 times the reduction in the mortgage balance. (1−(1−OMB!B43)*A!$B$96) i.e. (1−(1−% mortgage owed)×4.5)=(1−(1−0.985)×4.5)=93.25% meaning that when the mortgage balance declines to 98.5% of the mortgage face amount, the frequency drops to 93.25% times the original frequency percentage in a level or rising market i.e. 1.4 percent×93.25%=1.306.

A time sensitive frequency adjustment is achieved by multiplying the percentage reduction in the mortgage balance at any point in time by the frequency reduction factor shown in cell A!$B$96 (Assumptions tab A) in the accompanying model i.e. 4.5 One demonstrable result from introducing the frequency reduction factor in the accompanying spreadsheet is that the Subject MI can increase the projected frequency percentage from 1.4% to 4.9% when housing prices rise consistently over a ten year period and still enjoy a lower net claims cost than conventional MI providers.

To gain familiarity with the accompanying model it is helpful to experiment with both the frequency assumptions in Tab A, cells B90-E90 of the spreadsheet (HVG Financial Model-03 19 2015.xml, filed herewith on the accompanying CD), and Changes in Housing Prices Tab A, line 169. To see immediately the effect of changing frequency assumptions check Foreclosure Net Benefit cell E6. A positive number means that the Subject MI'S net claims costs are lower than those of a conventional MI providers without credit enhancements.

The Percentage frequency assumptions can be less than 1.0, e.g., 0.5, etc.

Severity—In the accompanying model/spreadsheet severity is the percentage below the mortgage balance at which the average underwater house is sold in a given year. For example, if an average mortgage balance is $100,000 in a given year and the selling price for this average house is $3,000 below the mortgage balance then the severity would be 3% i.e. 3,000/100,000.

Severity is the other key variable used to calculate the cost of underwater claims, once the relevant price range has been established. Severity in a given year is expressed as a percentage which varies with the housing price range into which the Relative Price Index has fallen e.g. a Relative Price Index of 99% would fit in the housing price range that is below the purchase price but above the mortgage balance.

The accompanying model assumes that the unadjusted severity of an average underwater house in a risen housing price market will equal 2.5% of the mortgage balance two years after mortgage loan origination. A decline in the percentage severity is correlated with the annual percentage decline in the mortgage balance of a 30 year mortgage loan i.e. 1½% per year. Specifically, the model assumes that the annual decrease in severity will be 4.5 times the percentage drop in mortgage balance or 0.0675% (0.015×4.5). Like all assumptions in the model, the percentage severity reduction factor (Tab A, cell B97) can be changed and will then produce a different result. In Equation 1 (shown below), the frequency assumption in a risen market, A!$B$90, and the severity assumption is a risen market, A!$B$94, are multiplied by a factor that causes it to decline at a greater rate than the mortgage balance declines e.g. (1−(1−0.985)×4.5)=0.9325. The segment of the Underwater Claims formula below says that, if prices are rising, underwater claims this year (2017) for policies written in Origination Year 1 (2016) will equal the value of mortgages insured in that origination year, $C$50, times the percentage of the mortgage loan still owed this year, OMB!B$43, times the percentage of loans written in year 1 that are redeemed this year (PSA), A!D$162, times (1.4% frequency×93.25%)×(2.5% severity×93.25%)=x:

=IF(A!D$169/A!$C$169>=1,MIN($C$50*OMB!B$43*A!D$162*A!$B$90*(1−(1−OMB!B43)*A!$B$96)*A!$B$94*(1−(1−OMB!B43)*A!$B$97 (Equation 1)

Severity assumptions (Refer to Assumptions Tab line 94): RPI>1 means that housing prices have risen; ((1−% DP)×% Mortgage Bal.)≦RPI<1 means that the sale price is below the purchase price but above the mortgage balance. The severity assumptions for RPI>1 and ((1−% DP)×% Mortgage Bal.)≦RPI<1 are shown below in Table 3:

TABLE 3

| | ((1 − % DP) × % Mortgage |
|---|---|
| | Bal.) ≦ RPI < |
| RPI > 1 severity % | 1 severity % |
| 2.5% | 4.5% |

The severity assumptions above are static. The severity assumption has been correlated with the mortgage balance to account for dynamism in the market i.e. that as the mortgage balance declines the percentage by which the selling price is below the mortgage balance should also decline. For example, the model projects that a mortgage balance of $100,000 at loan origination will be $85,000 after 10 years. If the percentage severity were 2.3% after 2 years it should not still be 2.3% after 10 years.

Below is the underwater claims formula (Equation 2) for Year 2 of projected Origination Year 1. There are no claims in the first year of any Origination Year because the percentage of mortgage balance payment cap in Year 1 is zero—which is designed to prevent paying claims to flippers.

=IF(A!D$169/A!$C$169>=1,MIN($C$50*OMB!B$43*A!D$162*A!$B$90*(1−(1−OMB!B43)*A!$B$96)*A!$B$94*(1−(1−OMB!B43)*A!$B$97),$C$50*OMB!B$43*A!D$162*A!$B$90*(1−(1−OMB!B43)*A!$B$96)*A!D$101),(IF(A!D$169/A!$C$169>=(1−A!$C$11)*OMB!B$43,MIN($C$50*OMB!B43*A!D$162*A!$C$90*(1−(1−OMB!B43)*A!$B$96)*A!$C$94*(1−(1−OMB!B43)*A!$B$97),$C$50*OMB!B43*A!D162*A!$C$90*(1−(1−OMB!B43)*A!$B$96)*A!D$101),(IF(A!D$169/A!$C$169>(1−A!$C$11)*OMB!B$43*(1−A!D$101),$C$50*OMB!B$43*A!D$162*A!$D$90*(1−(1−OMB!B43)*A!$B$96)*(((1−A!$C$11)*OMB!B43)−(A!D$169/A!$C$169)),$C$50*OMB!B$43*A!D$162*A!$E$90*(1-(1-OMB!B43)*A!$B$96)*A!D$101))))) (Equation 2)

Equation 2 can be broken down into three conditions. The first condition is shown below as Equation 3, the second condition is show below as Equation 4, and the third condition is shown below as Equation 5:

=IF(A!D$169/A!$C$169>=1,MIN($C$50*OMB!B$43*A!D$162*A!$B$90*(1−(1−OMB!B43)*A!$B$96)*A!$B$94*(1−(1−OMB!B43)*A!$B$97),$C$50*OMB!B$43*A!D$162*A!$B$90*(1−(1−OMB!B43)*A!$B$96)*A!D$101) (Equation 3)

(IF(A!D$169/A!$C$169>=(1−A!$C$11)*OMB!B$43,MIN($C$50*OMB!B43*A!D$162*A!$C$90*(1−(1−OMB!B43)*A!$B$96)*A!$C$94*(1−(1−OMB!B43)*A!$B$97),$C$50*OMB!B43*A!D162*A!$C$90*(1−(1−OMB!B43)*A!$B$96)*A!D$101) (Equation 4)

(IF(A!D$169/A!$C$169>(1−A!$C$11)*OMB!B$43*(1−A!D$101),$C$50*OMB!B$43*A!D$162*A!$D$90*(1−(1-OMB!B43)*A!$B$96)*(((1−A!$C$11)*OMB!B43)−(A!D$169/A!$C$169)) (Equation 5)

In Equation 3 (i.e., the first condition), IF the relative price index (i.e. the housing price index in 2017 relative to the housing price index in 2016) is greater than or equal to 1 times the portion of the loan owed (meaning that housing prices in the year of sale have either risen on average between the year the policy was written and the year the house is sold, or have remained constant, or have fallen but only by an amount such that the relative price index is equal to or greater than the portion of the loan owed [In this case 0.985]), THEN the claims amount equals THE LESSER OF the value of mortgages insured in the year that the relevant policies were issued net of attrition [i.e. net of cancelled or redeemed policies in that origination year] times adjusted PSA (the percentage of policies redeemed or cancelled in the year of sale) times the percentage of homes sold at a loss below the mortgage balance under that market pricing assumption times the average payout expressed as a percentage of the mortgage balance times the percentage of the mortgage owed; OR the value of mortgages insured in the year that the relevant policies were issued net of attrition [i.e. net of cancelled or redeemed policies in that origination year] times adjusted PSA (the percentage of policies redeemed or cancelled in the year of sale) times the percentage of homes sold at a loss below the mortgage balance under that market pricing assumption times the maximum phased in payout expressed as a percentage of the mortgage balance times the percentage of the mortgage owed.

OTHERWISE, the second condition (Equation 4) is evaluated. That is, IF the relative price index is below the percentage of the loan owed and IF the relative price index (i.e. the housing price index in 2017 relative to the housing price index in 2016) is greater than or equal to (1−the percentage down payment) times the percentage of the mortgage owed), THEN the claims amount equals THE LESSER OF the value of mortgages insured in the year that the relevant policies were issued net of attrition [i.e. net of cancelled or redeemed policies in that origination year] times adjusted PSA (the percentage of policies redeemed or cancelled in the year of sale) times the percentage of homes sold at a loss below the mortgage balance under that market (lower) pricing assumption times the average payout expressed as a percentage of the mortgage balance times the percentage of the mortgage owed OR the value of mortgages insured in the year that the relevant policies were issued net of attrition [i.e. net of cancelled or redeemed policies in that origination year] times adjusted PSA (the percentage of policies redeemed or cancelled in the year of sale) times the percentage of homes sold at a loss below the mortgage balance under that (lower) market pricing assumption times the maximum phased in payout expressed as a percentage of the mortgage balance times the percentage of the mortgage owed.

OTHERWISE, the third equation (Equation 5) is evaluated. That is IF the relative price index is below the percentage of the loan owed and IF the relative price index (i.e. the housing price index in 2017 relative to the housing price index in 2016) is greater than (1−the percentage down payment) times the percentage of the mortgage owed) times (1−the maximum phased in payout expressed as a percentage of the mortgage balance); THEN the claims amount equals the value of mortgages insured in the year that the relevant policies were issued net of attrition [i.e. net of cancelled or redeemed policies in that origination year] times the percentage of the mortgage loan owed times the adjusted PSA (the percentage of policies redeemed or cancelled in the year of sale) times the percentage of homes sold at a loss below the mortgage balance under that market pricing assumption times ((1−the down payment) times the percentage of the mortgage loan owed−(the relative price index)).

If the third condition is not met, then the final portion of Equation 1 (shown below as Equation 6) is evaluated.

$C$50*OMB!B$43*A!D$162*A!$E$90*(1−(1−OMB!B43)*A!$B$96)*A!D$101))))) (Equation 6)

OTHERWISE, the claims amount equals the value of mortgages insured in the year that the relevant policies were issued net of attrition [i.e. net of cancelled or redeemed policies in that origination year] times the percentage of the mortgage loan owed times the adjusted PSA (the percentage of policies redeemed or cancelled in the year of sale) times the percentage of homes sold at a loss below the mortgage balance under that market pricing assumption times the maximum phased in payout expressed as a percentage of the mortgage balance.

Foreclosure Claims Offset—the accompanying model's Underwater Claims benefit enables some borrowers who would otherwise have strategically defaulted not do so. For example, every borrower who would otherwise have strategically defaulted, has no reason to do so because the policy will pay the borrower the difference between the underwater sale price and the mortgage balance. Since all other costs remain the same, there is no advantage to giving back the house keys to the lender which would materially increase the cost of the strategic defaulter's credit and his/her ability to borrow may be curtailed.

The model's Underwater Claims benefit also enables some underwater homeowners who can no longer afford their mortgage payments i.e. non-strategic defaulters to avoid default and foreclosure. For example, many homes were purchased by borrowers whose combined income qualified them for their mortgage loan. When one income is lost and savings are depleted the mortgage payments are no longer affordable. This financial reality is exacerbated when the loan is underwater. The amount by which the home is underwater is added to the cost of relocation and in some cases would result in default and foreclosure. The model's Underwater benefit enables some underwater borrowers who can no longer afford to pay their mortgage to move without defaulting. This applies not only to families who will move and rent but also to families who will purchase an affordable house whose loan is qualified for by either one income or two incomes, one of which has been substantially reduced.

The pool of non-strategic defaulters is much larger than the pool of strategic defaulters but the percentage who can avoid default because of the Subject MI's policy benefits is much lower. (The model assumes that 100% of strategic defaulters will avail themselves of the Subject MI's underwater benefit). The model assumes that the pool of non-strategic defaulters insured by the Subject MI is ten times as large as the pool of strategic defaulters insured by the Subject MI and that 3.5% of these borrowers will avail themselves of this Underwater Claims benefit. As a result the number of non-strategic default claims avoided is approximately 35% (100×3.5%=3.5) of the number of strategic claims avoided (100/10×100%=10) because of this Underwater Claims benefit.

There is a relationship between housing prices and foreclosure avoidance. When housing prices have risen the number of foreclosures (frequency) is lower and the percentage of those foreclosures that are avoided is also lower.

In theory if all prices everywhere increased, there would never be a strategic default when prices have risen because no house would be underwater. That said, housing markets are granular. Specifically, there events that depress housing prices in particular markets while the national average of home prices increases. Some causes are natural disasters: hurricanes (Sandy, Irene), tornadoes, floods. Other causes are economic: plant closing, reduction in force, product obsolescence, off-shoring, commodity pricing (Oil Patch), tariffs and treaties, tax sheltering etc.

When housing prices fall, the number of defaults and foreclosures (frequency) increases. As a general rule the farther housing prices fall the higher the incidence of default and foreclosure. Concomitantly, the percentage of avoided foreclosures also increases when housing prices fall.

There are thresholds that cause the percentage of foreclosures avoided to increase. For example there is no opportunity for any policyholder to take advantage of this Underwater Claims benefit until the price of his/her home is underwater. The number of policyholders whose homes are underwater is correlated with declining housing prices. The deeper the average price declines the higher percentage of the Subject MI's policyholders who are likely to be underwater and the higher the percentage of avoided foreclosures will be.

The starting point for the accompanying model's estimates of the percentage of foreclosures avoided by its Underwater Claims benefit is that national housing prices are level or have risen. In that case the model projects that foreclosures will be reduced by 2% because of strategic defaults that will be avoided, and 7/10 percent 0.7% of foreclosures will be reduced because of non-strategic defaults that will be avoided (0.007/0.02=35%).

The model conservatively assumes that 4% of its policies will end in a completed foreclosure over the course of 10 years. A 2% reduction in foreclosures means that 0.08% (0.04×0.02=0.0008) of its policies that would otherwise have ended in strategic default will be surrendered and the insured house will be sold. In addition 0.028% (0.04×0.007=0.000278) of its policies that would otherwise have ended in non-strategic foreclosure will be surrendered and the insured house will be sold.

Rounding that means that approximately 1 house out of 1,000 Subject MI insured houses (0.04× (0.02+0.007)=0.108%) will avert a completed foreclosure due to the company's Underwater Claims benefit.

The model projects that the percentage foreclosure reduction will resemble (1−the Assumed Relative Price Index i.e. (1−the assumed housing price index at the time of sale divided by the assumed housing price index at the time of purchase). For example, for relative price indices of 100%, 85% and 70%, the following respective percentages for foreclosure reduction may be obtained: 2.7%, 13.5% and 25%.

The formula for determining the model's percentage foreclosure reduction is shown below in Equation 7:

=IF(C4>=C41,C43,IF(C4>=D41,D43,IF(C4>=E41,E43,IF(C4>=F41,F43,IF(C4>=G41,G43,IF(C4>=H41,H43,IF(C4>=I41,I43,IF(C4>=J41,J43,IF(C4>=K41,K43,IF(C4>=L41,L43,IF(C4>=M41,M43,IF(C4>=N41,N43,IF(C4>=O41,O43,IF(C4>=P41,P43,Q43)))))))))))))) (Equation 7)

In accordance with Equation 7, IF the actual Relative Price Index in 2016 [Tab UCR cell C4] is greater than or equal to the assumed Relative Price Index of 100% [Tab UCR cell C41] the percentage reduction in foreclosures will be 2.7%, but IF the first condition has not been met and the actual Relative Price Index is only greater than an assumed Relative Price Index of 97% [Tab UCR cell D41, then the percentage Reduction in Foreclosures will be 5.2% [Tab UCR cell D43] etc.

Statistical basis for the model's baseline frequency assumption (when prices are level)—there is a recognized statistical relationship between Standard Scores and Percentiles derived from Standard Normal Distribution. A Standard Score expresses an original score (value) in terms of standard deviations, as shown in Equation 8:

Standard Score=(Original score−mean)÷standard deviation

Or

x−μ/σ (Equation 8)

In this example, assume log normal distribution meaning in this case that the percentage by which housing prices are below that mortgage balance cannot be a negative number. When a percentage frequency of 1.4% is assumed the percentile is the (1.0−0.014) or 0.986 meaning that 98.6% of housing prices are not below the mortgage balance by a positive percentage. A percentile of 0.986 correlates to a Standard Score of 2.2 Standard Deviations (Refer to Table 4 below).

The mean housing price percentage when prices are level is 100%. The standard deviation percentage for houses that are sold below the mortgage balance by a positive number is 2.5% i.e. the average severity percentage (in the model, A!B94) is 2.5%. x is the Original Score (percentage) that results from this equation. Thus, in accordance with Equation 8:

(x−100%)÷2.5%=2.2

(x−1.0)=2.2×0.025

x−1=0.055

x=0.055+1

x=1.055(Original Score expressed as a decimal=105.5%)

If the average price of a house is $240,000 the difference between the price that produces a Standard Score of 2.2 with the above mean (100%) and standard deviation (2.5%) is 5.5% or $13,200; such that, assuming normal distribution, approximately 85% of average priced houses would sell between $253,200 and $226,800; and 15% would be sold at prices that are either higher or lower.

Standard Scores and Corresponding Percentiles from Standard Normal Distribution

TABLE 4

| Standard | |
|---|---|
| Score | Percentile |
| −3.4 | 0.03% |
| −3.3 | 0.05% |
| −3.2 | 0.07% |
| −3.1 | 0.10% |
| −3.0 | 0.13% |
| −2.9 | 0.19% |
| −2.8 | 0.26% |
| −2.7 | 0.35% |
| −2.6 | 0.47% |
| −2.5 | 0.62% |
| −2.4 | 0.82% |
| −2.3 | 1.07% |
| −2.2 | 1.39% |
| −2.1 | 1.79% |
| −2.0 | 2.27% |
| −1.9 | 2.87% |
| −1.8 | 3.59% |
| −1.7 | 4.46% |
| −1.6 | 5.48% |
| −1.5 | 6.68% |
| −1.4 | 8.08% |
| −1.3 | 9.68% |
| −1.2 | 11.51% |
| −1.1 | 13.57% |
| −1.0 | 15.87% |
| −.9 | 18.41% |
| −.8 | 21.19% |
| −.7 | 24.20% |
| −.6 | 27.42% |
| −.5 | 30.85% |
| −.4 | 34.46% |
| −.3 | 38.21% |
| −.2 | 42.07% |
| −.1 | 46.02% |
| 0.0 | 50.00% |
| +0.1 | 53.98% |
| +0.2 | 57.93% |
| +0.3 | 61.79% |
| +0.4 | 65.54% |
| +0.5 | 69.15% |
| +0.6 | 72.58% |
| +0.7 | 75.80% |
| +0.8 | 78.81% |
| +0.9 | 81.59% |
| +1.0 | 84.13% |
| +1.1 | 86.43% |
| +1.2 | 88.49% |
| +1.3 | 90.32% |
| +1.4 | 91.92% |
| +1.5 | 93.32% |
| +1.6 | 94.52% |
| +1.7 | 95.54% |
| +1.8 | 96.41% |
| +1.9 | 97.13% |
| +2.0 | 97.73% |
| +2.1 | 98.21% |
| +2.2 | 98.81% |
| +2.3 | 98.93% |
| +2.4 | 99.18% |
| +2.5 | 99.38% |
| +2.6 | 99.53% |
| +2.7 | 99.65% |
| +2.8 | 99.74% |
| +2.9 | 99.81% |
| +3.0 | 99.87% |
| +3.1 | 99.90% |
| +3.2 | 99.93% |
| +3.3 | 99.95% |
| +3.4 | 99.97% |

Unemployment Benefit—The model's unemployment benefit advances up to 6 months PITI (Principal, Interest, Taxes & Insurance) mortgage loan payments to the lender on behalf of involuntarily unemployed policyholders. The advance is repaid upon satisfaction of the mortgage pursuant to a sale, refinancing, or maturity. In the event of a completed foreclosure, the amount of the advance is deducted from the foreclosure payment owed to the lender.

The amount of the advances is calculated for each year in the model, as for example in IPG1!D86: =D352*A!D$143*A!D131 i.e. the number of foreclosure claims in a particular year×the cost of each advance×the assumed ratio of unemployment advances to foreclosures.

To calculate the number of expected foreclosure claims in a particular year from policies written in each Origination Year [e.g. in cell IPG1! D332] the formula is shown as below:

=D219/(A!$C$138*A!$C$105*A!D172) i.e. Foreclosure claims dollars÷(the loan amount×maximum payout to borrowers×outstanding mortgage percentage) (Equation 9)

Since the unemployment benefit is an advance and is either repaid or incorporated in a foreclosure claim payment there is no line item expense for it in the P&L. There is a line item for the foreclosure expense reduction in the P&L. The projected foreclosure payments is reduced by 8%, creating a cost advantage for the company.

The unemployment claims offset is based on a study commissioned by MassHousing and done by Ken Bjurstrom at Milliman. Milliman estimated that 1 in 12 of MassHousing's foreclosure claims [8%] would be avoided because of the unemployment benefit the agency offered. Specifically, MassHousing pays up to 6 months' principal and interest mortgage loan payments when the borrower produces unemployment checks. MassHousing verifies ongoing unemployment with MA DUA (Department of Unemployment Assistance). Based on 10 years' experience MassHousing estimates that the cost to offer its unemployment benefit is 5 bp, and the offsetting reduction in foreclosures is 15 by which is better than Milliman's estimate.

MassHousing's unemployment benefit is different from the Subject MI's unemployment benefit in that it is an outright grant rather than an advance that must be repaid. MassHousing's non-repayable grant benefits the borrower and therefore does not fall within the monoline requirement of Subject MI whereas the interest free advance provided by the Subject MI benefits the lender and qualifies as Subject MI. State housing finance agencies are not bound by the same Subject MI rules that apply to MI providers for conforming loans i.e. mortgage loans that meet GSE requirements.

D. IT Platform Build

The Subject MI may build a designed and scalable state of the art IT structure. Full integration with loan origination platforms is the centerpiece of this design. The IT structure may comprise servers, databases, insurance operating software, etc. One or more components of the IT system (insource or outsource) may utilize a universal data language i.e. Universal Loan Delivery Dataset (ULDD). The IT system will adhere to new mortgage regulations, as well as the GSE's common securitization platform which recently requires all mortgage industry participants to utilize the common data language.

The Subject MI'S proprietary technologies and products (e.g., exchange engine, business process engine, ULDD based Data Warehouse) will be integrated with industry exchanges, loan origination systems and servicing platforms. Specifically exchanges include Real EC (LPS), Core Logic, and Ellie Mae. Loan Origination Systems include Ellie Mae and IBM-Palisades. Servicing platforms include MPS (LPS), Fiserv, and Dovenmuehle. Embodiments described herein may be implemented by one or more of an exchange engine, business process engine, ULDD based Data Warehouse.

### III. Example Computer System Implementation

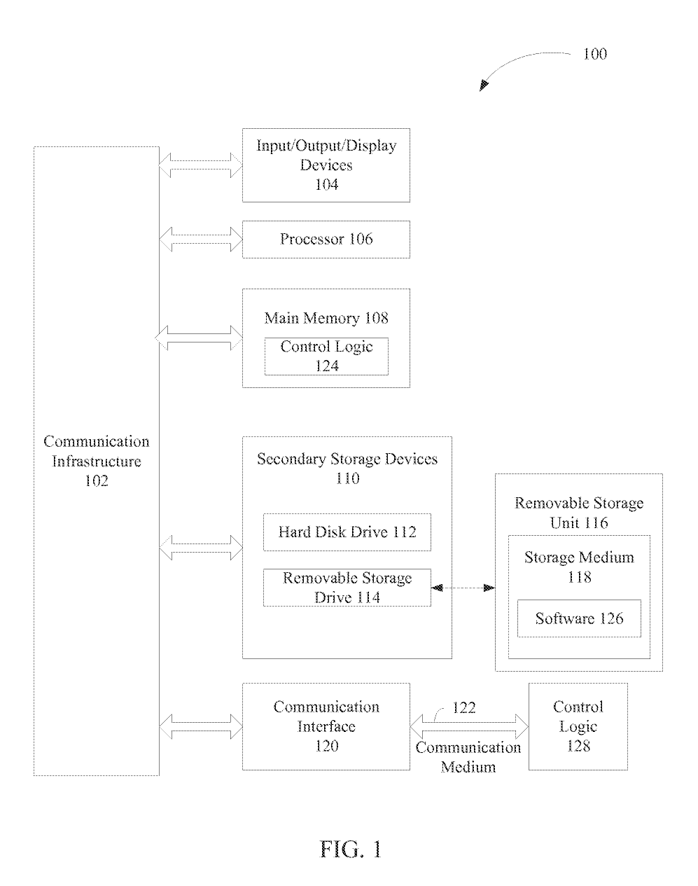

The embodiments described herein, including systems, methods/processes, and/or apparatuses, may be implemented using well known processing devices, telephones (land line based telephones, conference phone terminals, smart phones and/or mobile phones), interactive television, servers, and/or, computers, such as a computer 100 shown in FIG. 1. It should be noted that computer 100 may represent computing devices linked to, processing devices, traditional computers, and/or the like in one or more embodiments. For example, computing system, and any of the sub-systems, components, and/or models respectively contained therein and/or associated therewith, may be implemented using one or more computers 100.

Computer 100 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 100 may be any type of computer, including a desktop computer, a server, etc.

Computer 100 includes one or more processors (also called central processing units, or CPUs), such as a processor 106. Processor 106 is connected to a communication infrastructure 102, such as a communication bus. In some embodiments, processor 106 can simultaneously operate multiple computing threads, and in some embodiments, processor 106 may comprise one or more processors.

Computer 100 also includes a primary or main memory 108, such as random access memory (RAM). Main memory 108 has stored therein control logic 124 (computer software), and data.

Computer 100 also includes one or more secondary storage devices 110. Secondary storage devices include, for example, a hard disk drive 112 and/or a removable storage device or drive 114, as well as other types of storage devices, such as memory cards and memory sticks. For instance, computer 100 may include an industry standard interface, such a universal serial bus (USB) interface for interfacing with devices such as a memory stick. Removable storage drive 114 represents a floppy disk drive, a magnetic tape drive, a compact disk drive, an optical storage device, tape backup, etc.

Removable storage drive 114 interacts with a removable storage unit 116. Removable storage unit 116 includes a computer useable or readable storage medium 118 having stored therein computer software 126 (control logic) and/or data. Removable storage unit 116 represents a floppy disk, magnetic tape, compact disk, DVD, optical storage disk, or any other computer data storage device. Removable storage drive 114 reads from and/or writes to removable storage unit 116 in a well-known manner.

Computer 100 also includes input/output/display devices 104, such as touchscreens, LED and LCD displays, monitors, keyboards, pointing devices, etc.

Communication interface 120 enables computer 100 to communicate with remote devices. For example, communication interface 120 allows computer 100 to communicate over communication networks or mediums 122 (representing a form of a computer useable or readable medium), such as LANs, WANs, the Internet, etc. Network interface 120 may interface with remote sites or networks via wired or wireless connections.

Control logic 128 may be transmitted to and from computer 100 via the communication medium 122.

Any apparatus or manufacture comprising a computer useable or readable medium having control logic (software) stored therein is referred to herein as a computer program product or program storage device. This includes, but is not limited to, computer 100, main memory 108, secondary storage devices 110, and removable storage unit 116. Such computer program products, having control logic stored therein that, when executed by one or more data processing devices, cause such data processing devices to operate as described herein, represent embodiments.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the FIGURES, as well as any and all components, capabilities, and functions therein and/or further embodiments described herein.

Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media and signals transmitted over wired media. Embodiments are also directed to such communication media.

The techniques and embodiments described herein may be implemented as, or in, various types of devices. For instance, embodiments may be included in mobile devices such as laptop computers, handheld devices such as mobile phones (e.g., cellular and smart phones), handheld computers, and further types of mobile devices, desktop and/or server computers. A device, as defined herein, is a machine or manufacture as defined by 35 U.S.C. §101. Devices may include digital circuits, analog circuits, or a combination thereof. Devices may include one or more processor circuits (e.g., central processing units (CPUs) (e.g., processor 106 of FIG. 1), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### IV. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method of providing Subject MI by a provider, comprising:
providing conventional Subject MI to which credit enhancements have been added, which enable borrowers to remain in their homes rather than default on their mortgage payments leading to foreclosure and negative externalities,
wherein the credit enhancements include:
advances to lenders on behalf of involuntarily unemployed borrowers, such advances to be repaid upon satisfaction of the mortgage loan, or set off against payments owed to the lender in the event of completed foreclosure; and
payment upon resale of an insured property of the difference between a sale price of the property and a mortgage balance of the property, or between the mortgage balance and the market value of the property established by a recognized index of home values whichever is higher when the sale price or market value is lower than the mortgage balance;
wherein the cost of claims payments for each credit enhancement is more than offset by a reduction in the cost of foreclosures that are avoided because of the credit enhancements resulting in lower total claims costs for the provider, and
wherein the system comprises an IT platform that enables seamless integration of the credit enhancements with lender and servicer systems.

2. The method according to claim 1, wherein advances to lenders on behalf of borrowers are secured by a lien against the insured property.

3. The method according to claim 1, wherein borrowers on behalf of whom advances are made to lenders evidence indebtedness therefor by means of promissory note.

4. The method according to claim 1, wherein advances to lenders on behalf of borrowers aggregate to not more than 6 months of mortgage payments.

5. The method according to claim 1, wherein advances to lenders are non-interest bearing.

6. The method according to claim 1, wherein claims for payment when the market value is below the mortgage balance are subject to a vesting schedule.

7. The method according to claim 1, wherein claims for payment when the market value is below the mortgage balance are subject to a vesting schedule of 0, 6.25%, 12.5%, and 25% of the mortgage balance in the first four policy years respectively.

8. The method according to claim 1, wherein claims for payment when the market value is below the mortgage balance are subject to a cap.

9. The method according to claim 1, wherein claims for payment when the market value is below the mortgage balance are subject to a cap of 25%.

10. The method according to claim 1, wherein the IT platform integrates with Exchanges, Loan Origination Software, and Servicing Software integrated by proprietary components.

11. A method, comprising:
providing Subject MI with additional credit enhancements,
wherein the cost of concomitant claims is determined by formulas that are supported either by statistically valid analysis, long term data, or both, and
wherein the resulting reduction in the cost of projected foreclosures is based on conservative assumptions.

12. The method according to claim 11, wherein a cost of advancing mortgage payments paid to lenders on behalf of unemployed policyholders is approximately 5 by times Insurance in Force.

13. The method according to claim 11, wherein the reduction in foreclosure claims resulting from advances to involuntarily unemployed policyholders is equal to 15 by times Insurance in Force.

14. The method according to claim 11, wherein a cost of claims paid to underwater policyholders is determined by frequency and severity assumptions determined by a relative price index which is a local home value price index at the time of sale divided by the local home value price index at the time of purchase.

15. The method according to claim 11, wherein a cost of claims paid to underwater policyholders is determined by frequency and severity assumptions assigned to four price ranges which include rising or level home prices, home prices below the purchase price but above a mortgage balance, home prices below the mortgage balance but above the maximum mortgage balance percentage payout, home prices at or below the maximum mortgage balance percentage payout.

16. The method according to claim 11, wherein a cost of claims paid to underwater policyholders is determined by frequency and severity assumptions assigned to four price ranges as follows:
for level or rising home prices frequency is 1.4% and severity is 2.5%;
for home prices below the purchase price but above a mortgage balance frequency is 5.5% and severity is 4.5%;
for home prices below the mortgage balance but above the maximum mortgage balance percentage payout frequency is 65% and severity is based on a Relative Price Index; and
for home prices at or below the maximum mortgage balance percentage payout frequency is 80% and severity is 25%.

17. The method according to claim 11, wherein the reduction in foreclosure claims payments resulting from an availability of claims payments when a market price of a property is below a mortgage balance and the property is sold is calculated by conservative foreclosure offset assumptions.

18. The method according to claim 11, wherein the reduction in strategic default foreclosure claims resulting from an availability of claims payments when a market price of a property is below a mortgage balance and a Relative Price Index is =>1 is approximately 1 in 1,000 policies.

19. The method according to claim 11, wherein the reduction in strategic default foreclosure claims resulting from an availability of claims payments when a market price of an insured property is below a mortgage balance and a Relative Price Index is 67% is less than the percentage of foreclosure claims resulting from strategic defaults in the year when strategic defaults represented the highest percentage of foreclosure claims in US history.

20. The method according to claim 11, wherein the reduction in strategic default foreclosure claims resulting from an availability of claims payments when a market price of an insured property is below the mortgage balance and the Relative Price Index is 67% is 24%.
